(19) United States
(12) Patent Application Publication
(10) Pub. No.: US 2015/0140180 A1
(43) Pub. Date: May 21, 2015

(54) FOOD PRODUCT AND METHOD OF MAKING SAME

(71) Applicant: S'MORES & MORE, LLC, Wind Lake, WI (US)

(72) Inventor: Gary Kraeger, Wind Lake, WI (US)

(21) Appl. No.: 14/546,510

(22) Filed: Nov. 18, 2014

Related U.S. Application Data
(60) Provisional application No. 61/905,793, filed on Nov. 18, 2013.

(51) Int. Cl. A23G 3/54; A21D 13/08; A23G 1/54; A23G 3/52; A23G 3/56

(52) U.S. Cl. CPC A23G 3/54; A23G 3/52; A23G 3/566; A23G 1/54; A21D 13/08; A23V 2002/00
USPC 426/87; 426/93; 426/549

(57) ABSTRACT

An improved s'more-like food product allows the user to achieve the same taste profile as a conventional s'mores food product while greatly simplifying the preparation of the food product by the user. The improved s'more-like food product is pre-made such that the marshmallow element effectively “overwraps” the chocolate and graham cracker elements. This configuration provides a replica of a plain marshmallow, which is its aesthetic feature. That is, it looks like a traditional plain marshmallow which provides the consumer with some familiarity. However, this configuration is also functional in that it effectively eliminates mess during eating and provides a ready-to-heat product in a pre-made fashion which simplifies preparation of the s'more-like food product by the user. Edible wraps or cups can also be utilized to further enhance the eating experience and other flavors and other color variations for the food product can be provided depending on consumer preference.

This Application claims the benefit of U.S. Provisional Application No. 61/905,793, filed Nov. 18, 2013.

### FIELD OF THE INVENTION

The present invention relates generally to food, food products and edible food holders. It also relates generally to methods of making such food products. More specifically, the present invention relates to an improved configuration of a classic food product combination known in camping circles as a “s'more.” It also relates specifically to a preferred method of making the improved configuration and to a preferred method for consuming the improved food product.

### BACKGROUND OF THE INVENTION

Food and food products are well known and exist in a wide variety of ethnic and cultural combinations of food ingredients. One food product that can trace its roots to the traditional American “camp-out” is the s'more. A s'more is typically a food product comprised of chocolate, marshmallow and graham cracker elements. Most usually, a marshmallow is heated by using a stick or other implement to position the marshmallow in close proximity to the heat of a campfire. Once suitably warmed and somewhat fluid on its inside, the heated marshmallow is placed on top of a flat piece of chocolate, such as a portion of a chocolate bar, the chocolate piece being positioned atop a first graham cracker portion. A second graham cracker portion is then placed on top of the marshmallow and the graham cracker portions are squeezed together to form the s'mores food product, which is then ready to be consumed. In a traditional camp-out s'more, the graham cracker works as a heat retardant, an aspect of which is utilized in the food product and method of the present invention. Without it, the other s'more components would be difficult, if not impossible, to consume.

In the view of this inventor, the traditional s'mores product and the s'more-making process have several downsides to them. Perhaps most importantly is the fact that the traditional s'mores food product is messy to eat. This is primarily due to the fact that the melted marshmallow and chocolate bar often ooze out from between the graham cracker portions. The s'more-like food product can also be messy to eat because the graham cracker breaks. In some instances, the marshmallow element is not heated sufficiently to adequately melt the chocolate piece which can diminish the mouth-feel of the s'more-like food product for the user. Further, preparation for making the traditional s'mores food product often results in the user under-buying or over-buying the component parts of the s'mores food product—too much graham cracker, too little chocolate bar, etc. Also, and because the s'mores food product is typically a camp-side confection, preparation of the product is done in dimly-lit conditions which makes assembly difficult as well.

In the experience of this inventor, there is a need for an improved s'more-like food product that would eliminate the problems mentioned above. There is also a need to provide the user with a much simplified way of making the final edible s'mores product in the field.

### SUMMARY OF THE INVENTION

In accordance with the foregoing, the present invention provides an improved s'more-like food product that allows the user to achieve the same taste profile as a conventional s'mores food product while greatly simplifying the preparation of the food product by the user. In the improved s'more-like food product of the present invention, the s'more-like food product is pre-made such that the marshmallow element effectively “overwraps” the chocolate and graham cracker elements. That is, the chocolate and graham cracker elements are self-contained within the marshmallow element and the marshmallow element serves as an outer coating for the other elements. This configuration provides a replica of a plain marshmallow, which is its aesthetic feature. That is, it looks like a traditional plain marshmallow which provides the consumer with some familiarity. However, this configuration is also functional in that it effectively eliminates mess during eating and provides a ready-to-heat product that is presented in a pre-made fashion which greatly simplifies preparation of the s'more-like food product by the user. In the present invention, wraps or specially-configured cups can also be utilized to further enhance the eating experience. It is also within the scope of the present invention to include a “drilled” hole within several elements of the food product configuration, but not completely through it, to allow the user to more easily place a skewer into the food product. Lastly, other flavors and other color variations for the food product can be provided depending on the consumer's preference.

The foregoing and other features of the improved s'more-like food product and method of making same in accordance with the present invention will be apparent from the detailed description that follows.

### BRIEF DESCRIPTION OF THE DRAWINGS

FIG. 1 is a front and top perspective view of the improved s'more-like food product in accordance with the present invention.

FIG. 2 is a cross-sectioned side elevational view of the improved s'more-like food product taken along line 2-2 of FIG. 1.

FIG. 2A is a cross-sectioned side elevational view of a variation of the improved s'more-like food product.

FIG. 3 is a front and bottom perspective view of the improved s'more-like food product prior to placement into a specially-configured cup for further ease of consumption of the food product.

FIG. 4 is a front and top perspective view of the improved s'more-like food product prior to placement into another edible “wrap” for further ease of consumption of the food product.

FIG. 5 is a greatly enlarged cross-sectioned side elevational view of the edible wrap shown in FIG. 4 taken along line 5-5 of FIG. 4.

FIG. 6 is a view similar to that of FIG. 4 but showing the improved s'more-like food product placed into the edible wrap.

### DETAILED DESCRIPTION OF THE INVENTION

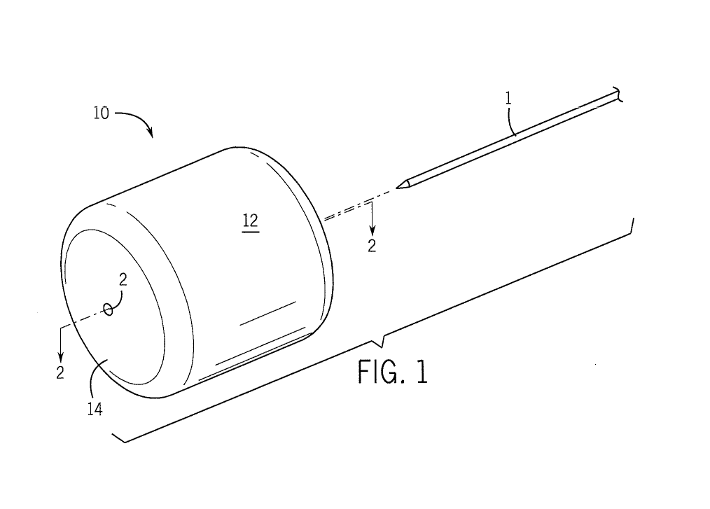

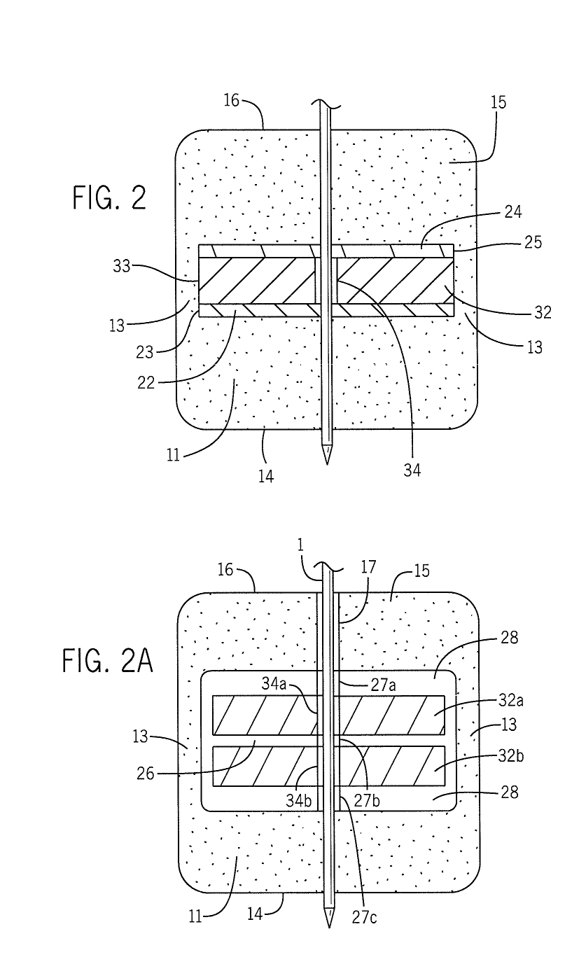

Referring now to the drawings in detail, wherein like-numbered elements refer to like elements throughout, FIG. 1 illustrates a s'more-like food product, generally identified 10, that is made in accordance with the present invention. From all outward appearances, the s'more-like food product 10 looks like a traditional plain marshmallow with the exception of dimples or food coloring dots 2 placed on the top and bottom surfaces 14, 16 of the marshmallow overwrap 12. The dots 2 are positioned to provide an indicia for the user as to where the s'more-like food product 10 should be skewered. That is, the dots 2 are place to indicate where a skewer 1 should pass through the s'more-like food product 10. It is also to be noted that the dots 2 are also positioned to align with a hole 34 that is defined within the graham cracker element 32. See FIG. 2.

In accordance with the present invention, and continuing with FIG. 2, it will be seen that the s'more-like food product 10 is constructed within a food mold (not shown) having the outer shape of a traditional round-shaped marshmallow having a flat top 14 and a flat bottom 16. It is also possible to alter this shape for novelty purposes.

The s'more-like food product 10 is made by placing a first layer 11 of white marshmallow element at the bottom of the mold, the first white marshmallow element layer 11 having an outer perimeter and a diameter. A first layer of melted chocolate 22 is then poured over the first marshmallow element layer 11, forming an outer peripheral edge 23 of the chocolate 22. This is carefully done so as to stay away from the outer margins 13 of that first marshmallow element layer 11. A graham cracker element 32 is then placed atop the first layer of melted chocolate 22. In the preferred embodiment, the graham cracker element 32 also has an outer peripheral edge 33 and the graham cracker element 32 has a diameter that is slightly less than that of the mold and the first white marshmallow element layer 11. Again, this provides for a margin between the outer peripheral edge 33 of the graham cracker element 32 and the mold. A second layer of melted chocolate 24 is then poured over the graham cracker element 32. That chocolate layer 24 similarly has a peripheral edge 25. Lastly, a second white marshmallow element layer 15 is added, which layer 15 covers the chocolate layers 22, 24 and the graham cracker element 32, including the peripheral edges 23, 25 of the chocolate layers 22, 24, respectively, and the peripheral edge 33 of the graham cracker element 32. Of course, all of the foregoing steps in constructing the s'more-like food product 10 can be mechanized or done by hand.

It should also be appreciated that there may be variations created within the marshmallow layers 11, 15, including multiple graham cracker elements 32 with corresponding chocolate layers that would be placed about those elements. For example, a specific preferred, but alternative, embodiment of the s'more-like food product 10 mentioned above includes two graham cracker elements 32a, 32b with a layer of chocolate 26 disposed between them. After that, the two graham cracker elements 32a, 32b and the chocolate layer 26 are further completely enveloped or coated with a full outer coating or layer 28 of chocolate. See FIG. 2A. Together, and as a unit, the combined graham cracker elements 32a, 32b and chocolate layers 26, 28 are placed onto the first marshmallow layer 11 and then coated by the second marshmallow layer 15. This particular preferred embodiment has been found to better melt and distribute the chocolate 26, 28 within the marshmallow layers 11, 15. As with the other embodiment, all portions of the inner elements 26, 28, 32 are contained within, and fully covered by, the marshmallow 11, 15, paying heed to maintain the outer marshmallow margin, as described above.

Further, it is also within the preferred embodiments to “drill” a skewer-receiving pilot hole 17 into the bottom 16 of the assembled food product 10. Again, see FIG. 2A, although the drilling or creation of a hole or holes within any combination of chocolate, graham cracker and marshmallow layers is within the scope of the present invention and is not limited to the embodiment shown in FIG. 2A. Drilling a pilot hole 17 into, but not completely through, the food product 10, has been found to preserve an undisturbed top surface 14 and thereby eliminate air flow through the food product 10, which helps preserve freshness. Further, the drilling of the pilot hole 17 also includes drilling holes 27a, 27b, 27c, 34a, 34b through the inner elements 26, 28, 32, respectively, which is beneficial because the chocolate layers 26, 28 tend to be harder elements and simply attempting to pierce them by force placed on the food product 10 could compromise the integrity of the food product 10. It also removes the potential for a user injuring himself or herself by applying excessive force to the food product 10 and stabbing himself or herself with the pointed end of the skewer 1. In this embodiment, it would still be advantageous to add a dot 2 to the top surface 14 such that the user could pierce the food product 10 from either its top surface 14 using the dot 2 or its bottom surface 16 using the pilot hole 17.

It should also be emphasized here that the graham cracker elements 32 and the chocolate layers 26, 28 are, in all embodiments of the present invention, completely enveloped by the marshmallow layers 11, 15 with no portion of the graham cracker elements 32 and the chocolate layers 26, 28 poking through the marshmallow layers 11, 15. This ensures that the inner elements 26, 28, 32 remain fully contained within the marshmallow 11,15 for best performance of the product 10.

Lastly, it is to be understood that other flavors and other color variations for the food product 10 can be provided depending on consumer preference.

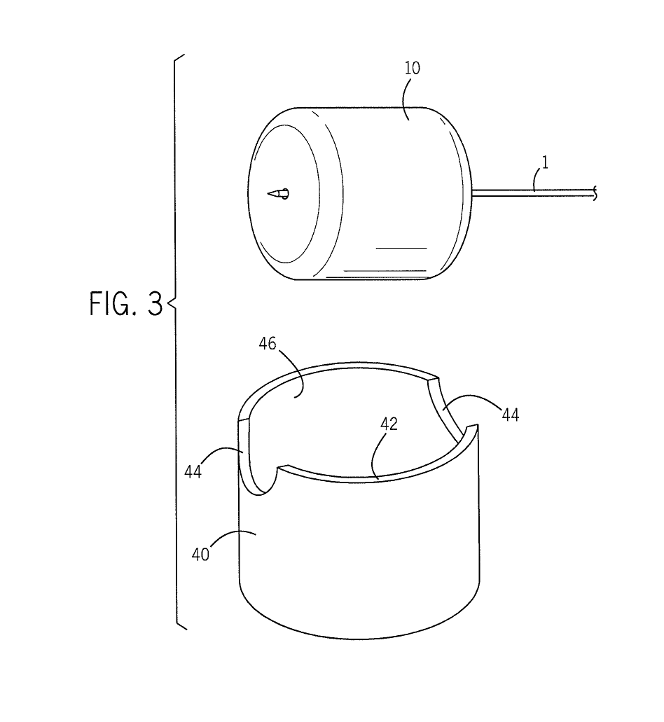

An additional feature of the s'more-like food product 10 of the present invention is that it can be provided with a specially-configured edible cup 40 much in the shape of a cupcake holder such that a plurality of the like-configured cups 40 can be stacked or “nested” for storage. See FIG. 3. The edible cup 40 provides a holder for the s'more-like food product 10 when such is desired. In its preferred embodiment, the cup 40 comprises a peripheral upper lip 42, the upper lip 42 comprising opposing divots 44. Further, it is preferable to coat the inside of the cup 40 with a chocolate lining 46. This cup 40 allows the user to position the s'more-like food product 10 above the cup 40 and then lower the food product 10 down into the cup 40 such that portions of the skewer 1 are disposed within a divot 44 to either side of the cup 40. The skewer 1 is then withdrawn from the cup 40, leaving the food product 10 to sit within the cup 40. This cup 40 makes the s'more-like food product 10 less messy and safer to eat. It is also made of ingredients that match the taste profile of the s'more-like food product 10 for enhanced taste.

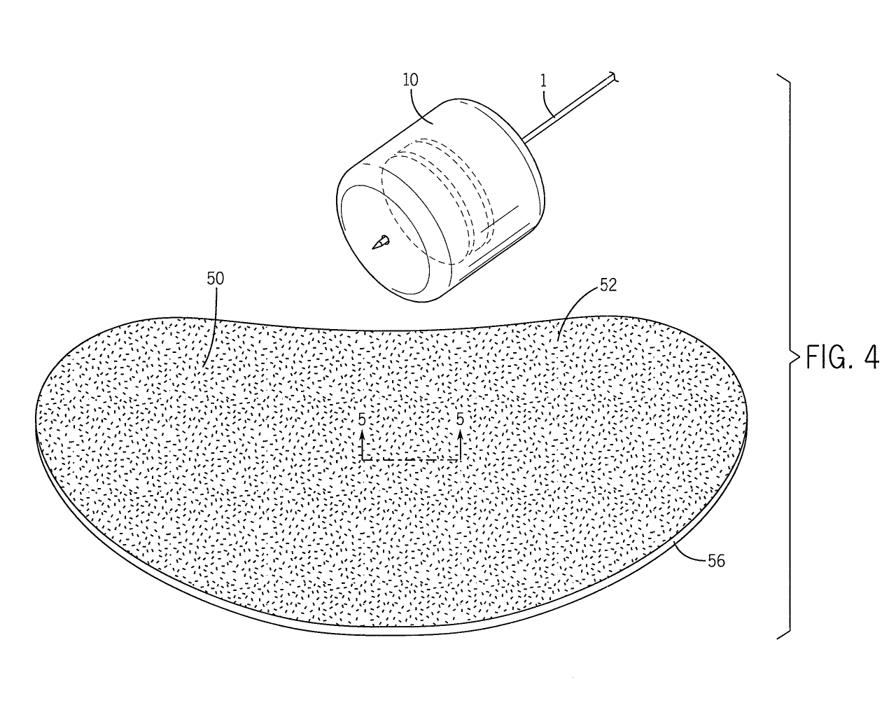

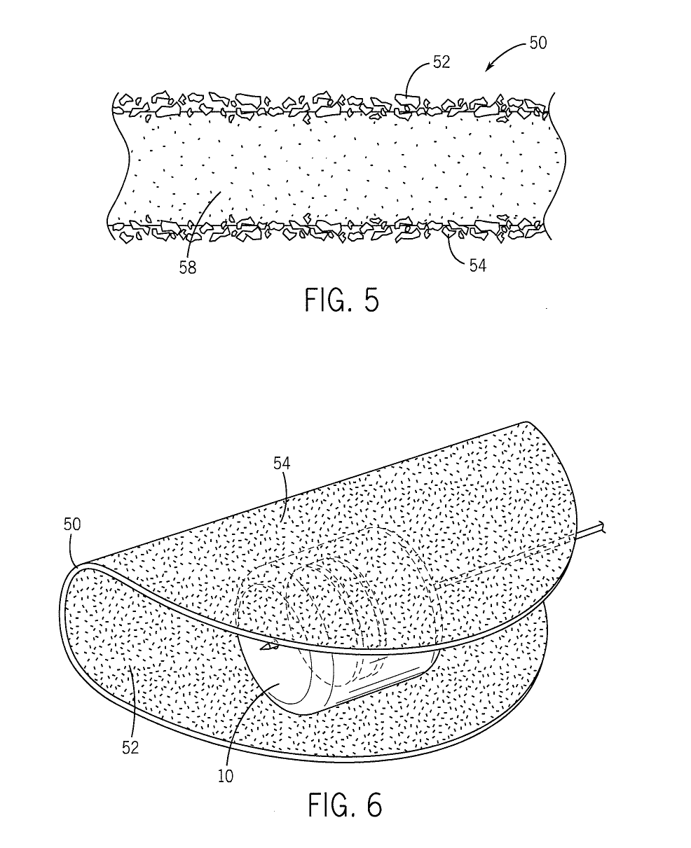

Referring now to FIG. 4, it shows another food product holder in the form of an edible wrap 50 which is made in the form of a round flat structure, which is shaped similar to that of a conventional tortilla but is a structure having a top face 52, a bottom face 54 and a peripheral edge 56. As shown in FIG. 5, it will be appreciated that the top and bottom faces 52, 54 are actually comprised of a graham cracker coating 53, 54 that is applied to a marshmallow disk 58. This wrap 50 is made by laying out a layer of marshmallow in a pan or other surface, covering the marshmallow layer with a crushed graham cracker coating, cutting out circular portions from the marshmallow layer and then dipping the wrap 50 in crushed graham crackers to achieve a graham cracker coating on both faces 52, 54 of the wrap 50. The diameter of the wrap 50 is not a limitation of the present invention. The cutting and coating described above can be mechanized or done by hand. The advantage to this edible wrap 50 is that it is much easier for the user to envelop the s'more-like food product 10. The wrap 50 allows the user to grasp the s'more-like food product 10 and remove it from the skewer 1. See FIG. 6. Further, the roasted food product 10 makes the wrap 50 taste like roasted marshmallow.

Although the coatings 53, 54 are shown in FIG. 5 to be relatively coarsely ground, it is to be understood that the coatings 53, 54 are almost powder-like in consistency. The advantage of having the coatings 53, 54 made of a finely-ground layer of graham cracker is that doing so enhances the ability of the graham cracker to adhere to the marshmallow disk 58. Further, and as was alluded to at the outset of this detailed disclosure, the graham cracker coatings 53, 54 actually work as a heat-retardant layer. Without the top face coating 53, the hot s'more-like food product 10 would melt through the wrap 50. The bottom face coating 54 insures that the user's fingers will not get sticky from the marshmallow disk 58. Much like its counterpart 40, this tortilla-shaped wrap 50 simply makes the s'more-like food product 10 less messy and safer to eat. Further, it is also made of ingredients that match the taste profile of the s'more-like food product 10 for enhanced taste, i.e., more graham cracker coating 53, 54 and more marshmallow 58.

In application, the user removes the s'more-like food product 10 from any wrapping (not shown) that is used to encase the s'more-like food product 10 and ensure product freshness. The user takes the skewer 1 and inserts it into the product 10 at one or the other of the two dots 2 formed on the surfaces 12, 14 of the product 10. The user pushes the skewer 1 through the product 10 which pierces the first layer of chocolate 22, passes through the hole 34 of the graham cracker element 32, pierces the second layer of chocolate 24 and exits through the opposing surface 12, 14 of the s'more-like food product 10. The skewered s'more-like food product 10 is then ready for heating over a fire or other heat source (also not shown). This melts the chocolate layers 22, 24. An added benefit of using the graham cracker element 32 with a hole 32 defined in it is that this structure prevents the marshmallow elements 11, 15 from “melting through” the skewer 1, as can happen when a conventional marshmallow is being toasted or roasted. When the product 10 is heated sufficiently to the liking of the user, it is ready for consumption. The s'more-like food product 10 can be eaten directly off of the skewer or placed within the cup 40 or the wrap 50.

In the alternative configuration where the s'more-like food product 10 is drilled with holes 17, 27a, 27b, 27c, 34a, 34b through the one layer of marshmallow 15 and the inner elements 26, 28, 32, respectively as previously described, the skewer 1 will be more easily inserted into the holes, thereby penetrating whatever number of cracker and chocolate elements are disposed within the product 10 via the holes disposed within each of those elements.

It is also within the scope of the present invention that alternative embodiments can be considered. For example, the s'more-like food product 10 could be made such that the marshmallow layers 11, 15 are flavored, such as by using chocolate ingredients (mainly cocoa) for a “double chocolate” s'more-like food product 10 to enhance the chocolate taste profile of the product 10. It would also be within the scope of the present invention to infuse the marshmallow layers 11, 15 with graham cracker ingredients to enhance the graham cracker taste profile of the s'more-like food product 10. It would also be within the scope of the present invention to treat the graham cracker elements 32, 53, 54 with a crisping agent for enhanced mouth feel and crunch of the food product 10.

It would also be within the scope of the present invention to add other layers to the chocolate and graham cracker layers 11, 15, 32 to further enhance or alter the taste profile of the s'more-like food product 10. Such a layer could, for example, include a peanut butter layer. It would also be possible to enhance the exterior of the s'more-like food product 10 by adding crushed graham cracker bits as a coating and other coatings are possible, as are other decorative elements.

It should also be mentioned that, in the view of this inventor, there are a number of ways to eat the s'more-like food product 10 of the present invention and the present invention is not limited in this regard. One could be to eat the food product 10 directly from the skewer. Another could be to use a piece of parchment paper to grasp the roasted product 10 from the skewer 1. The third could be to use a cup 40 as previously described, with or without the chocolate lining 46. The fourth could be to use the tortilla-like wrap 50, also as previously described. Another could be to use a microwave-safe container (not shown). The “cleanest” method of eating the roasted food product 10 is to eat it with the companion piece which is the tortilla-like wrap 50. It should also be understood that the s'more-like food product 10 of the present invention tends to expand when roasted. In point of fact, the food product 10 can expand up to about 30% when heated via microwave. Accordingly, the cups 40 and wraps 50 must be appropriately sized to accommodate this expansion.

In view of the foregoing, it will be apparent that the present invention provides an improved s'more-like food product that allows the user to achieve the same taste profile as a conventional s'mores food product while greatly simplifying the preparation of the food product by the user. That is, the consumer does not need to search out and purchase three different components, as is the case with a traditional s'mores combination. With the present invention, the improved s'more-like food product is pre-made so there is no guess work as to how much of each component to buy. Further, the chocolate layers in the food product of the present invention are themselves melted, and not just added to a warm marshmallow and a cold graham cracker because the marshmallow element completely overwraps the chocolate and graham cracker elements such that the chocolate and graham cracker elements are wholly self-contained within the marshmallow element. This configuration effectively eliminates mess during eating and provides a ready-to-heat product that is presented in a pre-made fashion which greatly simplifies preparation of the s'more-like food product by the user. In this fashion, there is no breakage of the graham cracker element and less waste. The smore-like food product of the present invention is simple and easy for the consumer to use while accomplishing the same taste profile as that of a conventional s'mores. Further, the food product is enhanced by integration of wraps that assist the user in eating the food product of the present invention and by the use of other ingredients and flavors added to the food product.

The details of the invention having been disclosed in accordance with the foregoing, I claim:

1. A food product comprising:
a first marshmallow element layer;
at least one layer of chocolate, the at least one layer of chocolate comprises an outer peripheral edge;
at least one graham cracker element, the at least one graham cracker element comprises an outer peripheral edge; and
a second marshmallow element layer;
wherein the first and second marshmallow element layers are round and further comprise an outer perimeter and have a diameter; and
wherein the outer peripheral edges of the at least one layer of chocolate and the at least one graham cracker element do not extend beyond the outer perimeter of the marshmallow and wherein the first and second marshmallow element layers fully envelop the other elements.

2. The food product of claim 1 wherein the first and second marshmallow element layers form a round peripheral side together with bottom and top surfaces.

3. The food product of claim 2 wherein the bottom and top surface of the food product comprise skewering indicia.

4. The food product of claim 1 wherein the first marshmallow element layer, the at least one graham cracker element and the at least one chocolate layer each comprise aligned holes for receiving a skewer.

5. The food product of claim 1 further comprising an edible wrap for holding the food product.

6. The food product of claim 5 wherein the edible wrap is formed from ingredients that match the taste profile of the other food product elements.

7. The food product of claim 5 wherein the edible wrap is formed in the shape of a tortilla.

8. The food product of claim 5 wherein the edible wrap is replaced by a specially-configured edible cup.

9. The food product of claim 8 wherein the edible cup, the food product or both are microwavable.

10. The food product of claim 1 wherein the food product comprises other taste profiles and colors.

11. A method for making a food product comprising the steps of:
providing a first marshmallow element layer;
providing at least one layer of chocolate;
providing at least one graham cracker element; and
providing a second marshmallow element layer.

12. The method of claim 10 further comprising the following steps:
making the first marshmallow element layer round and having an outer perimeter and a diameter;
making the at least one layer of chocolate with an outer peripheral edge; and
making the at least one graham cracker element with an outer peripheral edge;
wherein the outer peripheral edges of the at least one layer of chocolate and the at least one graham cracker element do not extend beyond the outer perimeter of the marshmallow and wherein the first and second marshmallow element layers fully envelop the other elements.

13. The method claim 11 further comprising the step of forming the first and second marshmallow element layers with a round peripheral side together with bottom and top surfaces.

14. The method of claim 13 wherein the bottom and top surface of the food product comprise skewering indicia.

15. The method of claim 11 further comprising the step of drilling aligned holes through one marshmallow element layer, the at least one graham cracker element and the at least one chocolate layer for receiving a skewer.

16. The method of claim 11 further comprising the step of providing an edible wrap for holding the food product.

17. The method of claim 16 wherein the edible wrap is formed from ingredients that match the taste profile of the other food product elements.

18. The method of claim 16 wherein the edible wrap is formed in the shape of a tortilla.

19. The method of claim 16 wherein the edible wrap is replaced by a specially-configured edible cup.

20. The method of claim 19 wherein the edible cup, the food product or both are microwavable.

21. The method of claim 16 wherein the food product comprises other taste profiles and colors.
